(19) United States
(12) Patent Application Publication
(10) Pub. No.: US 2026/0133082 A1
(43) Pub. Date: May 14, 2026

(54) A MAGNETIC TACTILE SENSOR ARRANGEMENT

(71) Applicant: THE SHADOW ROBOT COMPANY LTD, London (GB)

(72) Inventors: John Hugo Elias, London (GB); Rory Thompson, London (GB)

(21) Appl. No.: 19/118,335

(22) PCT Filed: Oct. 4, 2023
(86) PCT No.: PCT/IB2023/059967

§ 371 Date: Apr. 3, 2025

(30) Foreign Application Priority Data
Oct. 4, 2022 (GB) 2214592.4

(51) Int. Cl. G01L 1/12; B25J 9/16; G01L 5/22

(52) U.S. Cl. CPC G01L 1/12; B25J 9/1694; G01L 5/228

(57) ABSTRACT

A magnetic tactile sensor arrangement A magnetic tactile sensor arrangement comprises a flexible inner layer (2) and a flexible outer layer (3), the inner and outer layers (2, 3) sandwiched together adjacent to one another in use; sat least one magnetic sensor element (4) located substantially at or on the inner surface of the two layers (2, 3), the magnetic sensor element (4) comprising a magnetic sensor (7) and sensor cup (8), the magnetic sensor (7) locating into the cup (8) in use, the sensor cup (8) configured so that in use the majority of the sensor element (7) is enclosed within the sensor cup (8), the sensor cup (8) formed from a ferrous material.

### FIELD

The present invention relates to a magnetic tactile sensor arrangement. More particularly, the present invention relates to a magnetic tactile sensor arrangement suitable for use in a robotic end effector or similar.

### BACKGROUND

In many fields, it is necessary to determine when contact has been made between objects, and relative motion of the objects in contact. For example, contact between a user's fingers and the surface of a touchpad/trackpad, contact between the hand of a user and a touch control panel or similar, etc.

In the field of robotics, when picking up or gripping objects with the end effector at the end of a robotic arm, it is important to know the location of the end effector relative to the object, and to be able to determine the point at which the end effector makes contact with the object. Similarly, it is also important to know the alignment of the end effector relative to the object when contact is made, and also the force exerted when a grip or similar is exerted. Such sensing is particularly important if the end effector and/or object to be grasped is/are relatively delicate.

Touchpads commonly work via capacitive sensing, where the change in capacitance is detected at the point where a finger contacts the pad. Capacitance sensing generally works very poorly with materials other than direct skin contact (for example stylus contact, or contact with a gloved finger).

Larger control surfaces or contact surfaces are becoming more common, for example in use on car dashboards or similar. In these applications, capacitive touch sensing may not be the most appropriate due to the larger surface area, the required robustness of the panel, and similar requirements.

A number of types of tactile sensor are already known in the field of robotics. For example, the “TacTip” sensor, developed at Bristol Robotics Laboratory, includes a flexible curved surface, on the inner (concave) surface of which are provided a number of pins (or papillae). A camera captures an image of the inner ends of the pins. When the surface is deformed by contact with an object, the inner ends of the pins move, and this movement can be seen by the camera. However, forming the curved surface with the pins is not straightforward; 3D printing is possible, but 3D printed materials are not particularly robust. Further, a considerable depth is needed to accommodate the pins, so the sensor has a minimum size, and may not be suitable for more delicate applications.

The “GelSight” sensor, developed at MIT's Computer Science and Artificial Intelligence Laboratory, uses a block of transparent rubber with a contact surface coated with a metallic paint. When the painted surface is pressed against an object, it conforms to the shape of the object. The side of the block opposite the contact surface is illuminated by three differently-coloured lights, and imaged by a camera. The camera captures images of the deformed surface in three different colours, and uses these to determine the shape of the object. Although this type of sensor gives a good image of the object, it does not provide a good representation of the tangential or normal forces involved in the contact, and does not allow small surface vibrations to be measured and localized. Further, since the metallic paint is exposed and contacted by the object, the sensor is vulnerable to wear. The sensor is also quite large, and again may not be suitable for more delicate applications.

The use of magnetic sensor elements for tactile sensors is also known. Magnetic elements and a detector element or elements are embedded into a material layer, with the material in which the sensors are embedded being at least partly flexible and deformable. As the outer surface of the material makes contact with objects, it deforms, and the magnetic elements move relative to the detector element or elements. This relative movement of the magnetic elements and the detector allows changes in the magnetic field at the detector(s) to be measured, and used to calculate position and force. A typical arrangement for the material and the magnetic elements is shown in FIGS. 1 and 2, with the sensor comprising magnetic elements sandwiched between an outer layer of flexible material, and an inner layer. The magnetic elements are held in place by gluing these to the inner surface of the outer layer with a suitable adhesive. However, as shown in FIG. 2, in an arrangement such as this, it can be difficult to retain the magnetic elements in the required position over extended periods of use, as these can become loosened and moved out of the required position due to shearing forces and other deformation forces exerted on the layers in use.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a magnetic tactile sensor arrangement which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a magnetic tactile sensor arrangement, comprising: a flexible inner layer and a flexible outer layer, the inner and outer layers sandwiched together adjacent to one another in use; at least one magnetic sensor element located substantially at or on the inner surface of the two layers, the magnetic sensor element comprising a magnetic sensor and sensor cup, the magnetic sensor locating into the cup in use, the sensor cup configured so that in use the majority of the magnetic sensor is enclosed within the sensor cup, the sensor cup formed from a ferrous material.

In an embodiment, the cup is arranged to face inwards.

In an embodiment, the sensor element is substantially flat, one side and the edge or edges of the sensor element substantially enclosed within the sensor cup.

In an embodiment, the sensor element comprises a coin-or disc-shaped magnetic element.

In an embodiment, the sensor element has a diameter of substantially 3 mm and a height/thickness of 0.5 mm.

In an embodiment, the magnetic sensor is formed from samarium cobalt.

In an embodiment, the sensor cup comprises a side wall and base, the sensor element and cup configured so that the side wall extends past the side wall/edge of the magnetic sensor.

In an embodiment, the thicknesses of the side wall and base are sufficient so that the cup material is not magnetically saturated by the magnetic sensor element.

In an embodiment, the wall has a thickness of substantially 0.45 mm, and the base of the cup has a thickness of substantially 0.4 mm.

In an embodiment, the base and outer edge of the wall are chamfered to a depth of substantially between 0.2 mm and 0.3 mm.

In an embodiment, the sensor element comprises a 3×0.5 mm samarium cobalt magnet.

In an embodiment, one or both of the inner and/or outer layer are formed from a flexible elastomer material.

In an embodiment, one or both of the inner and/or outer layer are formed from silicone.

In an embodiment, at least one sensor holder is integrally formed with one of the layers and located between the layers, the sensor holder configured to receive the magnetic sensor element so that in use the magnetic sensor element remains in position within the holder and move with the holder.

In an embodiment, the at least one sensor holder comprises a cavity formed in the layer.

In an embodiment, the cavity has a depth of substantially 1 mm.

In an embodiment, the at least one sensor holder comprises a protrusion extending from and forming part of the inner surface of a layer, the cavity formed within the protrusion.

In an embodiment, the protrusion is substantially twice the height of the depth of the cavity.

In an embodiment, the protrusion has the general form of a cut-off or truncated cone.

In an embodiment, the cut plane of the cone is substantially parallel to the main body of the layer.

In an embodiment, the outer wall or slope of the cone is angled at between 45 and 60 degrees to the cut plane.

In an embodiment, the protrusion is substantially circular in plan view, the cavity substantially central within the protrusion in plan view.

In an embodiment, the overall height of the cut cone is substantially 2 mm.

In an embodiment, the protrusion is formed on the inner surface of the outer layer.

In an embodiment, the at least one sensor holder comprises a plurality of sensor holders.

In an embodiment, the sensor holders are arranged in at least one substantially straight line.

In an embodiment, the sensor holders are arranged in parallel lines.

In an embodiment, the magnetic tactile sensor arrangement further comprises at least one Hall effect sensor located in or on the inner layer.

In an embodiment, the at least one Hall effect sensor comprises a Hall effect sensor or sensors, each of the Hall effect sensor or sensors associated with a magnetic sensor element.

In an embodiment, the magnetic tactile sensor arrangement is configured so that the Hall effect sensor or sensors are located substantially between 1 mm-2 mm from the inner surface of an associated magnetic sensor element.

In a second aspect, the invention may broadly be said to consist in a magnetic tactile sensor arrangement, comprising: a flexible inner layer and a flexible outer layer, the inner and outer layers sandwiched together adjacent to one another in use; at least one sensor holder integrally formed with one of the layers and located between the layers, the sensor holder configured so that a sensor located in the holder will, in use, remain in position within the holder and move with the holder.

In an embodiment, one or both of the inner and/or outer layer are formed from a flexible elastomer material.

In an embodiment, one or both of the inner and/or outer layer are formed from silicone.

In an embodiment, the at least one sensor holder comprises a cavity formed in the layer.

In an embodiment, the cavity has a depth of substantially 1 mm.

In an embodiment, the at least one sensor holder comprises a protrusion extending from and forming part of the inner surface of a layer, the cavity formed within the protrusion.

In an embodiment, the protrusion is substantially twice the height of the depth of the cavity.

In an embodiment, the protrusion has the general form of a cut-off or truncated cone.

In an embodiment, the cut plane of the cone is substantially parallel to the main body of the layer.

In an embodiment, the outer wall or slope of the cone is angled at between 45 and 60 degrees to the cut plane.

In an embodiment, the protrusion is substantially circular in plan view, the cavity substantially central within the protrusion in plan view.

In an embodiment, the overall height of the cut cone is substantially 2 mm.

In an embodiment, the protrusion is formed on the inner surface of the outer layer.

In an embodiment, the at least one sensor holder comprises a plurality of sensor holders.

In an embodiment, the sensor holders are arranged in at least one substantially straight line.

In an embodiment, the sensor holders are arranged in parallel lines.

In an embodiment, the magnetic tactile sensor arrangement further comprises a magnetic sensor element configured to locate into the sensor holder, the magnetic sensor element comprising a magnetic sensor and sensor cup, the sensor locating into the cup in use, the sensor cup configured so that in use the majority of the sensor element is enclosed within the sensor cup, the sensor cup formed from a ferrous material.

In an embodiment, the sensor element is substantially flat, one side and the edge or edges of the sensor element substantially enclosed within the sensor cup.

In an embodiment, the sensor element comprises a coin-or disc-shaped magnetic element.

In an embodiment, the sensor element has a diameter of substantially 3 mm and a height/thickness of 0.5 mm.

In an embodiment, the magnetic sensor is formed from samarium cobalt.

In an embodiment, the sensor cup comprises a side wall and base, the sensor element and cup configured so that the side wall extends past the side wall/edge of the magnetic sensor.

In an embodiment, the thickness of the wall and base is sufficient so that the cup material is not magnetically saturated by the magnetic sensor element.

In an embodiment, the wall has a thickness of substantially 0.45 mm, and the base of the cup has a thickness of substantially 0.4 mm.

In an embodiment, the base and outer edge of the wall are chamfered to a depth of substantially between 0.2 mm and 0.3 mm.

In an embodiment, the cup is arranged within the sensor holder so that most or all of those parts of the sensor element not enclosed within the sensor cup face inwards. In an embodiment, the sensor element comprises a 3×0.5 mm samarium cobalt magnet.

In an embodiment, the magnetic tactile sensor arrangement further comprises at least one Hall effect sensor located in or on the inner layer.

In an embodiment, the at least one Hall effect sensor comprises a Hall effect sensor or sensors, each of the Hall effect sensor or sensors associated with a magnetic sensor element.

In an embodiment, the magnetic tactile sensor arrangement is configured so that the Hall effect sensor or sensors are located substantially between 1 mm-2 mm from the inner surface of an associated magnetic sensor element.

In a third aspect the invention may broadly be said to consist in a robotic end effector comprising a magnetic tactile sensor arrangement as outlined in any one of the second aspect statements above.

In a fourth aspect, the invention may broadly be said to consist in a robotic arm comprising an end effector as outlined in the third aspect statement above.

In a fifth aspect, the invention may broadly be said to consist in a sensor cup for use with a magnetic tactile sensor assembly, comprising: a cup body configured to receive a magnetic sensor, the cup body configured so that in use the majority of the magnetic sensor is enclosed within the sensor cup, the sensor cup formed from a ferrous material.

In an embodiment, the cup body comprises a side wall and base, the thickness of the wall and base sufficient so that the cup material is not magnetically saturated by a magnetic sensor located in the cup body.

In an embodiment, the side wall is configured so that in use with a magnetic sensor located in the cup body, the side wall extends past the side wall/edge of the magnetic sensor.

In an embodiment, the cup body is substantially cylindrical.

In an embodiment, the wall has a thickness of substantially 0.45 mm, and the base of the cup has a thickness of substantially 0.4 mm.

In an embodiment, the base and outer edge of the wall are chamfered to a depth of substantially between 0.2 mm and 0.3 mm.

In a sixth aspect, the invention may broadly be said to consist in a robotic end effector comprising at least one sensor cup as outlined in any one of the fifth aspect statements above.

In a seventh aspect, the invention may broadly be said to consist in a robotic arm comprising an end effector as outlined in the sixth aspect statement above.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a schematic cutaway side view of a portion of a known, prior art magnetic tactile sensor showing the general arrangement of a flexible and deformable inner elastomer layer and a flexible and deformable outer elastomer layer, with magnetic elements of the sensor positioned between the inner and outer layers.

FIG. 2 shows the sensor of FIG. 1 in use, showing deformation of the elastomer layers when force is applied by pressing into and along the surface of the outer layer, and the subsequent movement of the magnetic sensor elements relative to the layers.

FIG. 3 shows a schematic cutaway side view of a portion of a general layout applicable to an embodiment of the magnetic tactile sensor of the present invention, showing flexible and deformable inner and outer layers, the cross-sectional profile of sensor holders formed in the outer elastomer layer and extending inwards, and magnetic sensor assemblies located in the holders.

FIG. 4 shows a cutaway perspective view from one side and above of the general layout of the sensor of FIG. 3 in use, showing deformation of the elastomer layers when force is applied to the sensor by pressing into and along the surface of the outer layer in a similar manner to that shown in the prior art sensor of FIG. 2, the figure showing the movement of the holders and magnetic sensor assemblies.

FIG. 5 shows a schematic cutaway side view of the outer layer of FIG. 3, showing detail of a sensor holder formed in the outer layer.

FIG. 6 shows a cutaway view from the side and slightly above of a portion of a general layout applicable to an embodiment of the magnetic tactile sensor of the present invention, showing the cross-sectional profile of the sensor holders formed in the outer elastomer layer, and the composition of the magnetic sensor assemblies that locate into the sensor holders in use, the magnetic sensor assemblies each comprising a flat coin-or disc-shaped magnetic sensor, and a sensor cup into which the magnetic sensor locates so that the sensor is fully surrounded and enclosed on one flat side and it's edge, the side wall of the cup extending past the open side of the magnetic sensor.

FIG. 7 shows a perspective view from above and to one side of a cross-section of robotic end effector fitted with a series of magnetic tactile sensors according to an embodiment of the present invention, showing the arrangement of the sensor holders on the inner surface of the of the outer elastomer layer, and Hall effect sensors embedded in the inner elastomer layer above the magnetic tactile sensors.

FIG. 8 shows a perspective side view of a single magnetic sensor assembly and a Hall effect sensor, the Hall effect sensor in use embedded in the inner elastomer layer (not shown) and the magnetic sensor assembly located in a holder that in use is located on/in the outer layer (not shown), the Hall effect sensor and the magnetic sensor assembly in use positioned relative to one another substantially as shown, the Hall effect sensor in use measuring changes in the magnetic field from the magnet as this moves relative to the Hall effect sensor, as the elastomer layers are deformed such as for example in the same or similar manner as shown in FIG. 4.

FIG. 9 shows the unconstrained magnetic field of a flat coin-shaped magnetic sensor of the type used as part of the invention.

FIG. 10 shows the sensor of FIG. 9 located in a sensor cup, showing schematically the manner in which the magnetic field is constrained by the cup.

FIG. 11 shows a cross-sectional side view of the cup, showing dimensional detail of the cup.

### DETAILED DESCRIPTION

Embodiments of the invention, and variations thereof, will now be described in detail with reference to the figures.

One preferred embodiment of the present invention uses magnetic sensor assemblies 4 that in this embodiment are embedded into an end effector or similar that forms part of a robotic hand. This will be described in detail below.

The invention is also suitable for use in a number of other applications, which are detailed at the end of the description.

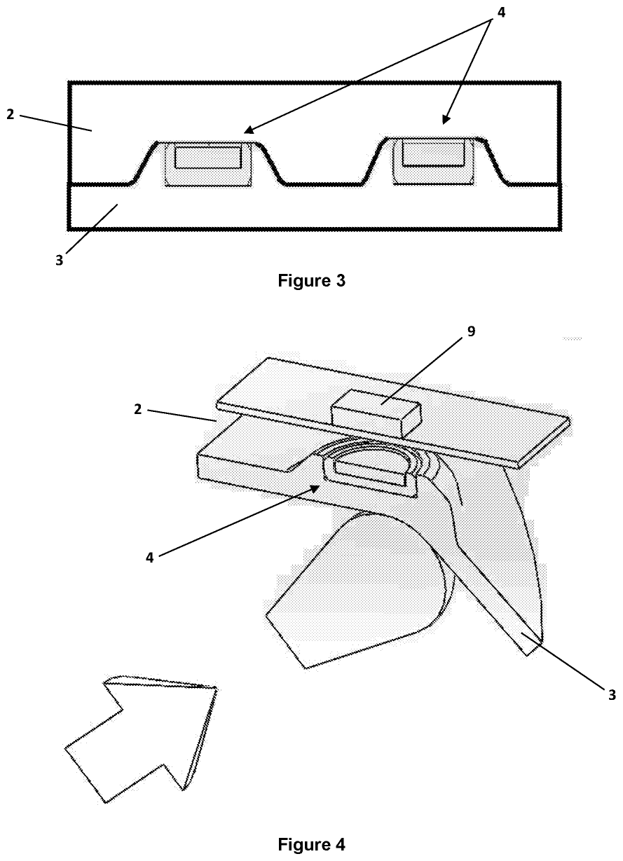

As shown in FIG. 3, the magnetic tactile sensor arrangement used with the tactile sensor in an end effector 1 comprises three main elements: an inner layer 2; an outer layer 3, and; magnetic sensor assemblies 4.

### Inner and Outer Layers

The inner and outer layers 2 and 3 are formed of a flexible elastomer material, such as for example silicone. The inner and outer layers 2, 3 are sandwiched together in use. In this embodiment, the two layers are directly adjacent to one another. However, in other embodiments, the two layers could be separate by one or more ‘filling’ layers, or central layers. ‘Sandwiched’ as used in this specification should be taken to mean that the inner and outer layers are either directly adjacent to one another, or separated by one or more layers.

This embodiment of outer layer 3 comprises a number of sensor holders 5 that are integrally formed as part of the outer layer 3, on the inner surface of the outer layer 3, as shown in FIG. 3.

As noted, there is an inner layer and an outer layer. Where ‘inner surface’ or similar is used in this specification, this should be taken to mean on the inside of, or between, the two sandwiched layers, e.g. that side of the outer layer that faces towards the inner layer.

In alternative forms, the sensor holders could be formed on the inner surface of the inner layer (that side of the inner layer that faces towards the outer layer), or holders could be formed on both the inner sides of both of the inner and outer layer.

As shown in FIG. 7, in an embodiment the holders 5 can be arranged in substantially parallel lines along the inner surface of the outer layer 3. However, the sensor holders 5 can be positioned relative to one another as required, in numbers as required, and in a pattern as required, for any particular use. A single holder could also be used, if a single sensor only is required in a particular embodiment.

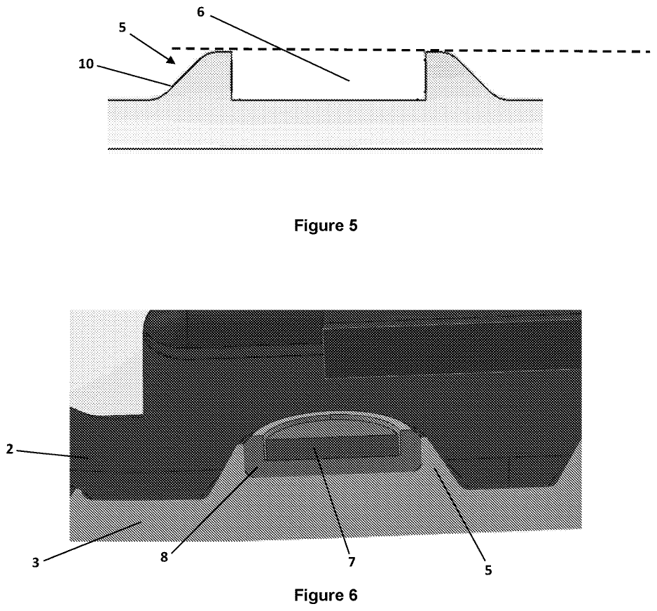

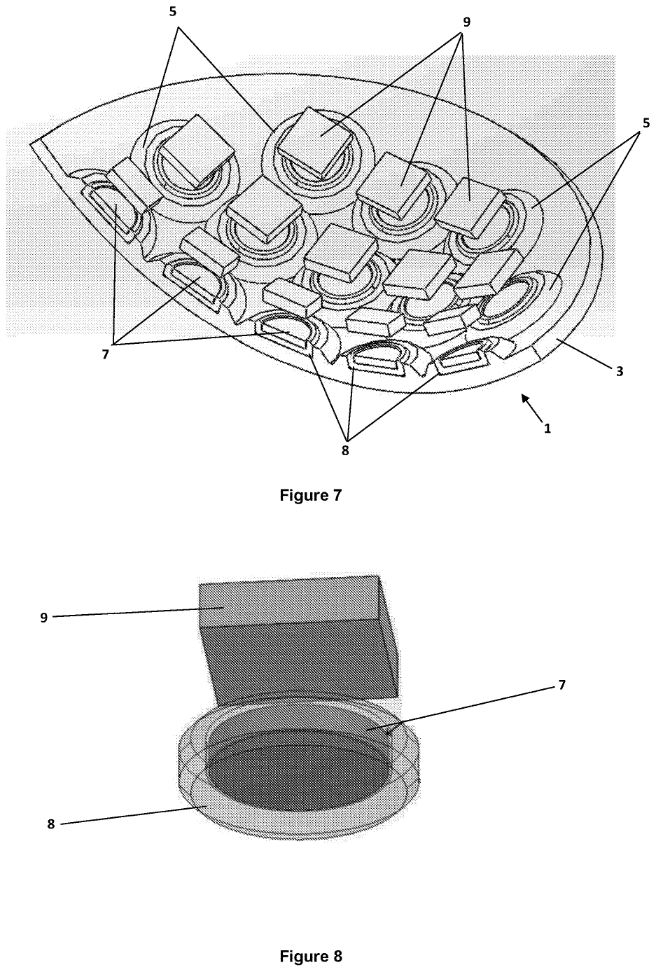

FIG. 5 shows a cross-section view of a holder 5. In the preferred form, each of the sensor holders 5 comprises a bulge or protrusion on the inner surface of the outer layer 3 that has the general form of a cut-off or truncated cone, with a central cavity 6. In the preferred embodiment the ‘cut’ plane of the cone (shown by the dotted line on FIG. 5) is substantially parallel to the outer surface of the outer layer. The outer wall or slope 10 of the holder 5 is at an angle to the ‘cut’ plane, and for variations this angle can be between 45 and 60 degrees. The central cavity 6 is circular in plan view, and has a depth of substantially 1.0 mm, which is approximately half of the overall height of the cut cone.

In use, as shown in FIG. 4, the holder 5 acts to retain a magnetic sensor assembly 4 embedded/located in the central cavity 6, so that the magnetic sensor assembly 4 is in use located in the required position on the inner surface of the outer layer 3, and is held in position during repeated use without becoming loose and out of position.

The sensor holders for the preferred embodiment as described above are bulges or protrusions that extend from the surface of the layer. In alternative forms, these could be formed as cavities within the layer itself—that is, the layer would not require bulges or protrusions in order for the sensor holders to be formed directly into the layer. ‘Between’ as used in this specification should be taken to mean substantially directly at the contact surface between the inner and outer layers, or slightly to one side of/adjacent to this.

### Magnetic Sensor Elements

Each of the magnetic sensor elements 4 comprises a magnetic sensor 7 and sensor cup 8.

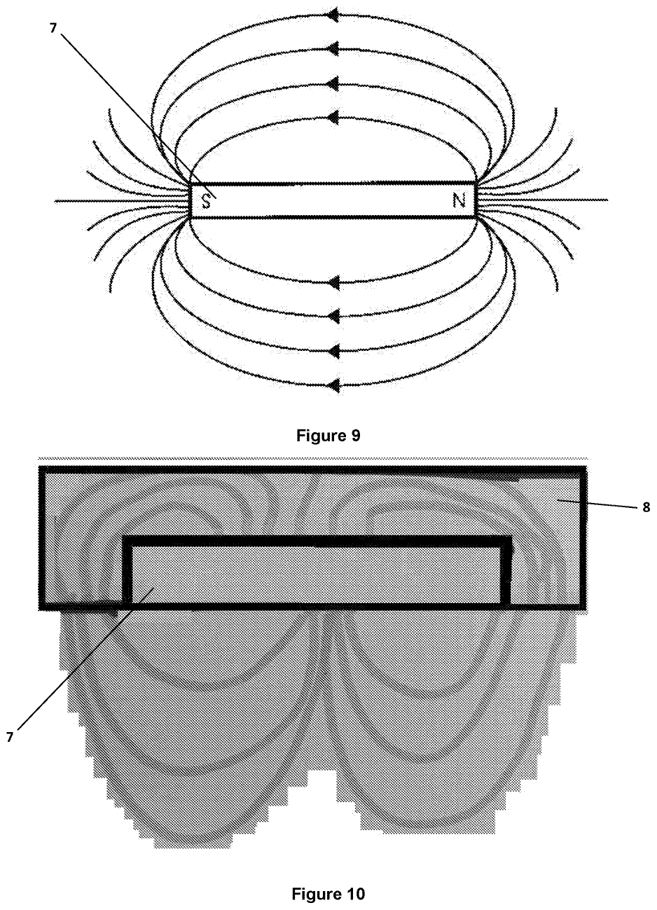

The magnetic sensor 7 comprises a coin-or disc-shaped magnetic element, having a diameter in the preferred embodiment of 3 mm and a height/thickness of 0.5 mm. As shown in FIG. 9, the magnetic field lines for the unrestrained sensor extend over and around the magnet, with the poles of the magnet located on each of the opposed faces of the disc. In the preferred embodiment, the magnetic sensor is formed from samarium cobalt.

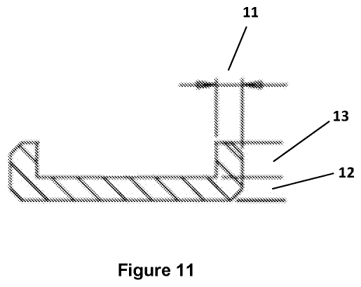

The magnetic sensor 7 and sensor cup 8 are formed so that the magnetic sensor 7 locates snugly into the sensor cup 8. The sensor cup 8 is configured so that with the magnetic sensor 7 snugly located in the sensor cup 8, the sensor 7 is fully surrounded/enclosed at it's edge and on that flat side facing towards the ‘inside’ of the cup (that side towards the outer side of the outer layer in use). The opposed flat side of the sensor 7 is fully free (that side which in use faces inwards, ‘out’ of the cup 8). The sensor cup 8 is sized so that the side wall of the cup 8 extends slightly past the side wall/edge of the magnetic sensor 7, and has an overall height of substantially 1 mm, as shown by dimension ‘13’ on FIG. 11.

Detail of the sensor cup 8 is shown in FIG. 11. In the preferred embodiment the cup 8 has a wall thickness of 0.45 mm (shown by dimension ‘11’), and a base thickness of 0.4 mm (shown by dimension ‘12’). The base and outer edge of the wall are chamfered to a depth of substantially between 0.2 mm and 0.3 mm. The wall/base thickness is intended to be sufficient so that the cup material is not magnetically saturated. So, for example in the preferred embodiment, the wall thickness is at least 0.4 mm for a 3×0.5 mm samarium cobalt magnet. The wall/base thickness can be varied for variations of the sensor, depending on the strength of the magnet used in a particular variation/embodiment.

The sensor cup 8 is formed of a ferrous material, which constrains the magnetic field from the magnetic element. In use, with the magnetic sensor 7 located into the sensor cup 8, the magnetic field is constrained on the cup side/enclosed side as shown in FIG. 10, with the field lines more concentrated on the constrained side than they are on the free or open side.

The magnetic field lines are significantly less concentrated on the opposite side (the side that faces the external surface of the tactile sensor). This helps to reduce any magnetic fields which would travel through ferrous materials in the vicinity of the tactile sensor, affecting the magnetic field on the reverse side (towards the Hall sensor). This helps to reduce any offsets on the tactile sensor caused by nearby ferrous objects. This also assists with reducing the magnetic field on the outwards-facing surface, which could for example lead to undesirable results such as the unwanted collection of loose metallic objects such as metal swarf/filings on the outer surface.

The sensor cup 8 as described above is sized so as to be suitable for constraining a particular size of magnetic sensor 7. The sizes of both the magnetic sensor 7 and cup 8 can be changed as required, so that the magnetic field is suitable for a particular purpose, and is suitably constrained for that particular use. Different types and shapes of magnet can also be used, with the shape and size of the cup adjusted accordingly.

In use, the cup 8 is glued into the cavity 6. The shape of the interior of the cavity is configured to allow the adhesive to bond around the steel of the external surfaces of the cup 8.

### Use

In use, as the tactile sensor contacts items, the inner and outer layers 2 and 3 will deform in a similar manner to that shown in FIG. 4.

As shown in FIGS. 4 and 8, a Hall effect sensor 9 is embedded in the inner elastomer layer 2 in a position relative to the magnetic element of the magnetic sensor 7 that is substantially in line with the central axis of the circular coin of the magnetic sensor 7. The Hall effect sensor 9 is in a preferred variation located a distance of substantially 1 mm-2 mm from the inner surface of the magnetic sensor 7. The Hall effect sensor 9 is used to measure changes in the magnetic field from the magnetic sensor 7 as this moves relative to the Hall effect sensor 9, as the elastomer layers are deformed as for example shown in FIG. 4.

The ‘open or unconstrained side of the cup 8 faces the Hall effect sensor 9. The constraining effect of the cup has the effect of producing a more powerful magnetic field for the Hall effect sensor to measure, resulting in a higher sensitivity (see for example FIG. 10).

The Hall effect sensor 9 is connected to a controller or similar (not shown) which receives the readings from the Hall effect sensor and uses these to help assess position and grip of the end effector.

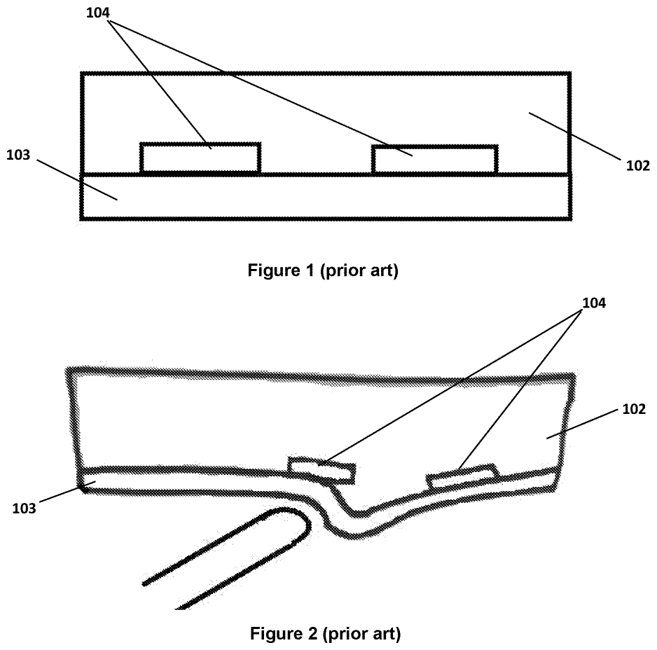

In the prior art arrangement (magnetic elements 104 and inner and outer layers 102, 103 as shown in FIGS. 1 and 2) and as outlined above, the magnetic elements 104 can come unstuck and out of position during use. In the embodiment of the present invention, the sensor holders 5 act to keep the magnetic sensors 7 in the required location on the inner surface of the outer layer 3 during use, and increase the ability of the sensor to endure heavy impacts and forces. The ‘peeling’ force shown in FIG. 2 is diverted to a sheering force (as shown in FIG. 4) which is more easily resisted.

In the description above, the invention is particularly described in relation to an end effector for a robotic arm. However, the invention should not be taken as being limited to this particular use. It should be noted that the invention is suitable for use in many other applications where a touch sensitive system is required. For example, the system could be used to form a, or part of, a touchpad, a keyboard (either for typing, drafting, or a musical instrument), a control panel (such as those in automobiles or similar) and many other similar uses.

To achieve this, the layers of material that contain the magnetic sensor arrangement can be arranged in a flat sheet, or as a sheet shaped for the particular purpose required (e.g. over a curved surface, or wrapped around a cylinder or sphere, or similar). The arrangement could also be used for individual buttons or similar (although it will be appreciated that the invention is also suited to sliding contact or moving contact over a surface, or similar). When a user is in contact with the surface, this will cause movement of the magnetic element or elements away from their neutral positions, and relative to the Hall sensor or sensors. This detected output, when received at a central controller or similar, can be used to assess user input, and therefore required output from the controller.

1.-70. (canceled)

71. A magnetic tactile sensor arrangement, comprising:
a flexible inner layer and a flexible outer layer, the inner and outer layers sandwiched together adjacent to one another in use;
at least one magnetic sensor element located substantially at or on the inner surface of the two layers, the magnetic sensor element comprising a magnetic sensor and sensor cup, the magnetic sensor locating into the cup in use, the sensor cup configured so that in use the majority of the magnetic sensor is enclosed within the sensor cup, the sensor cup formed from a ferrous material.

72. A magnetic tactile sensor arrangement as claimed in claim 71 wherein the cup is arranged to face inwards.

73. A magnetic tactile sensor arrangement as claimed in claim 71 wherein the sensor element is substantially flat, one side and the edge or edges of the sensor element substantially enclosed within the sensor cup.

74. A magnetic tactile sensor arrangement as claimed in claim 71 wherein the sensor element comprises a coin-or disc-shaped magnetic element.

75. A magnetic tactile sensor arrangement as claimed in claim 71 wherein the magnetic sensor is formed from samarium cobalt.

76. A magnetic tactile sensor arrangement as claimed in claim 71 wherein the sensor cup comprises a side wall and base, the sensor element and cup configured so that the side wall extends past the side wall/edge of the magnetic sensor.

77. A magnetic tactile sensor arrangement as claimed in claim 76 wherein the thicknesses of the side wall and base are sufficient so that the cup material is not magnetically saturated by the magnetic sensor element.

78. A magnetic tactile sensor arrangement as claimed in claim 71 wherein one or both of the inner and/or outer layer are formed from a flexible elastomer material.

79. A magnetic tactile sensor arrangement as claimed in claim 71 wherein at least one sensor holder is integrally formed with one of the layers and located between the layers, the sensor holder configured to receive the magnetic sensor element so that in use the magnetic sensor element remains in position within the holder and move with the holder.

80. A magnetic tactile sensor arrangement as claimed in claim 79 wherein the at least one sensor holder comprises a cavity formed in the layer.

81. A magnetic tactile sensor arrangement as claimed in claim 80 wherein the at least one sensor holder comprises a protrusion extending from and forming part of the inner surface of a layer, the cavity formed within the protrusion.

82. A magnetic tactile sensor arrangement as claimed in claim 81 wherein the protrusion is substantially twice the height of the depth of the cavity.

83. A magnetic tactile sensor arrangement as claimed in claim 81 wherein the protrusion has the general form of a cut-off or truncated cone.

84. A magnetic tactile sensor arrangement as claimed in claim 83 wherein the outer wall or slope of the cone is angled at between 45 and 60 degrees to the cut plane.

85. A magnetic tactile sensor arrangement as claimed in claim 81 wherein the protrusion is substantially circular in plan view, the cavity substantially central within the protrusion in plan view.

86. A magnetic tactile sensor arrangement as claimed in claim 81 wherein the protrusion is formed on the inner surface of the outer layer.

87. A magnetic tactile sensor arrangement as claimed in claim 79 wherein the at least one sensor holder comprises a plurality of sensor holders.

88. A magnetic tactile sensor arrangement as claimed in claim 87 wherein the sensor holders are arranged in parallel lines.

89. A magnetic tactile sensor arrangement as claimed in claim 71 further comprising at least one Hall effect sensor located in or on the inner layer.

90. A magnetic tactile sensor arrangement as claimed in claim 89 configured so that the Hall effect sensor or sensors are located substantially between 1 mm-2 mm from the inner surface of an associated magnetic sensor element.
